(19) United States
(12) Patent Application Publication
(10) Pub. No.: US 2025/0021869 A1
(43) Pub. Date: Jan. 16, 2025

(54) MACHINE LEARNING BASED SYSTEM AND METHOD FOR OPTIMIZING TRAINING TIME OF A MACHINE LEARNING MODEL

(71) Applicant: ParallelDots, Inc., Seattle, WA (US)

(72) Inventors: Muktabh Mayank Srivastava, Gorakhpur (IN); Angam Parashar, Gwalior (IN); Ankit Narayan Singh, Rishikesh (IN)

(21) Appl. No.: 18/350,001

(22) Filed: Jul. 11, 2023

(51) Int. Cl. G06N 20/00

(52) U.S. Cl. CPC G06N 20/00

(57) ABSTRACT

A machine learning based system for optimizing training time of a machine learning model is disclosed. The machine learning based system configured to: (a) train the machine learning model on second plurality of data associated with second one or more images corresponding to first one or more products, (b) extract third plurality of data associated with third one or more images corresponding to second one or more products from a database, (c) learn to recognize the third one or more images by fine-tuning the machine learning model trained on the second one or more images, using transfer learning method, (d) fine-tune a subset of the machine learning model to recognize third one or more analyzed images, and (e) analyze fourth one or more images corresponding to the second one or more products using the fine-tuned subset of trained machine learning model trained on third one or more recognized images.

### FIELD OF INVENTION

Embodiments of the present disclosure relate to machine learning based systems, and more particularly relate to a machine learning based system and method and system for optimizing training time of a machine learning model.

### BACKGROUND

Generally, consumer packaged goods (CPG) companies frequently launch new products and regularly update their packaging designs to attract customers and maintain competitiveness in a market. The update in the packaging designs requires utilization of computer vision algorithms to recognize and identify retail products. When initiating a new project aimed at recognizing products of a CPG company with limited annotated training data, there is a need for a machine learning model (i.e., a product image recognition model) to be trained and deployed rapidly.

Fine-tuning is a technique used in transfer learning, where weights of a pre-trained machine learning model are trained on a new dataset. Fine-tuning provides an option to perform adjustments either on a complete neural network or on a specific subset of complete neural network's layers.

While fine-tuning the entire machine learning model is a common practice and often leads to improved results, the fine-tuning comes with higher computational costs. Additionally, fine-tuning the complete neural network on the new dataset requires significant time and resources.

Therefore, there is a need for an improved machine learning based system and method for optimizing training time of a machine learning model, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine learning based system for optimizing training time of a machine learning model, is disclosed. The machine learning based system includes one or more hardware processors and a memory unit coupled to the one or more hardware processors. The memory unit comprises a set of program instructions in form of a plurality of subsystems, configured to be executed by the one or more hardware processors. The plurality of subsystems comprises a data obtaining subsystem, a data training subsystem, a data extracting subsystem, an image analyzing subsystem, and a fine-tuning subsystem.

The data obtaining subsystem is configured to obtain a plurality of data associated with first one or more images. The first one or more images are obtained from an imagenet database.

The data training subsystem is configured to train the machine learning model based on a second plurality of data associated with second one or more images corresponding to first one or more products. The second one or more images in a database comprises one or more images corresponding to the first one or more products, irrespective of whether the second one or more images comprises of one or more products on which the trained machine learning model is to be performed.

The data extracting subsystem is configured to extract a third plurality of data associated with third one or more images corresponding to second one or more products from the database. The third one or more images corresponding to the second one or more products, are pre-stored in the database.

The image analyzing subsystem is configured to learn to recognize the third one or more images corresponding to the second one or more products by fine-tuning the machine learning model trained on the second one or more images corresponding to the first one or more products, using a transfer learning method. A number of the first one or more products is higher than a number of the second one or more products.

The fine-tuning subsystem is configured to fine-tune at least one subset of the trained machine learning model to recognize the third one or more analyzed images corresponding to the second one or more products.

The image analyzing subsystem is configured to analyze fourth one or more images corresponding to the second one or more products using the fine-tuned at least one subset of the trained machine learning model trained on the third one or more recognized images corresponding to the second one or more products, using the transfer learning method.

The fine-tuned at least one subset of the trained machine learning model trained on the third one or more images, is required during learning to analyze the second one or more products. The fourth one or more images comprises one or more real world test images corresponding to the second one or more products. The fine-tuned at least one subset of the trained machine learning model is performed for analyzing the one or more real world test images corresponding to the second one or more products.

In an embodiment, in training the machine learning model based on the second plurality of data associated with the second one or more images corresponding to the first one or more products, the data training subsystem is configured to: (a) receive the second plurality of data associated with the second one or more images corresponding to the first one or more products, (b) provide a first plurality of labels related to the second one or more images corresponding to the first one or more products, to the machine learning model, and (c) train the machine learning model by correlating the second one or more images corresponding to the first one or more products, with the plurality of labels related to the second one or more images. The plurality of labels comprises at least one of: objects comprised in, coordinates, color information, and metadata, of the one or more images. The machine learning model is a supervised machine learning model.

In another embodiment, in analyzing, using the transfer learning method, the third one or more images corresponding to the second one or more products, the image analyzing subsystem is configured to: (a) obtain the third one or more images corresponding to the second one or more products from the database, and (b) provide a second plurality of labels related to the third one or more images corresponding to the second one or more products. The second plurality of labels comprises of names of the second one or more products to fine-tune the machine learning model.

In an embodiment, the fine-tuning is a transfer learning technique in which the machine learning model trained to recognize the first one or more images, is retrained to recognize the second one or more images corresponding to the first one or more products. The machine learning model is retrained on the second one or more images corresponding to the first one or more products. The fine-tuning subsystem is configured to fine-tune the machine learning model trained on the first one or more images infrequently.

In yet another embodiment, in fine-tuning the at least one subset of the trained machine learning model, the fine-tuning subsystem is configured to train weights of the at least one subset of the machine learning model already fine-tuned on the second one or more images corresponding to the first one or more products. The at least one subset of the machine learning model is retrained on the third one or more images corresponding to the second one or more products.

In yet another embodiment, in analyzing, using the transfer learning method, the fourth one or more images corresponding to the second one or more products, the image analyzing subsystem is configured to: (a) obtain the fourth one or more images corresponding to the second one or more products, (b) provide the fourth one or more images corresponding to the second one or more products, to the fine-tuned at least one subset of the machine learning model, (c) apply the trained weights of the fine-tuned at least one subset of the machine learning model, on the fourth one or more images corresponding to the second one or more products, and (d) analyze the fourth one or more images corresponding to the second one or more products, based on the trained weights of the fine-tuned at least one subset of the machine learning model applied on the fourth one or more images corresponding to the second one or more products. The fourth one or more images corresponding to the second one or more products comprises the one or more real world test images for analysis.

In yet another embodiment, the image analyzing subsystem is configured to analyze the fourth one or more images corresponding to the second one or more products, by providing probabilistic values to the fourth one or more analyzed images corresponding to the second one or more products, between 0 and 1.

In yet another embodiment, the machine learning model is a convolutional neural network (CNN) model.

In yet another embodiment, the first one or more products and the second one or more products are different products.

In one aspect, a machine learning based method for optimizing training time of a machine learning model, is disclosed. The machine learning based method includes obtaining, by one or more hardware processors, a plurality of data associated with first one or more images. The first one or more images is obtained from an imagenet database.

The machine learning based method further includes training, by the one or more hardware processors, the machine learning model on a second plurality of data associated with second one or more images corresponding to first one or more products. The second one or more images in a database comprises one or more images corresponding to the first one or more products, irrespective of whether the second one or more images comprises of one or more products on which the trained machine learning model is to be performed.

The machine learning based method further includes extracting, by the one or more hardware processors, a third plurality of data associated with third one or more images corresponding to second one or more products from the database. The third one or more images corresponding to the second one or more products, are pre-stored in the database.

The machine learning based method further includes learning to recognize, by the one or more hardware processors, the third one or more images corresponding to the second one or more products by fine-tuning the machine learning model trained on the second one or more images corresponding to the first one or more products, using a transfer learning method. A number of the first one or more products is higher than a number of the second one or more products

The machine learning based method further includes fine-tuning, by the one or more hardware processors, at least one subset of the trained machine learning model to recognize the third one or more analyzed images corresponding to the second one or more products.

The machine learning based method further includes analyzing, by the one or more hardware processors, fourth one or more images corresponding to the second one or more products using the fine-tuned at least one subset of the trained machine learning model trained on the third one or more recognized images corresponding to the second one or more products, using the transfer learning method.

The fine-tuned at least one subset of the trained machine learning model trained on the third one or more images, is required during learning to analyze the second one or more products. The fourth one or more images comprises one or more real world test images corresponding to the second one or more products. The fine-tuned at least one subset of the trained machine learning model is performed for analyzing the one or more real world test images corresponding to the second one or more products.

In an embodiment, training the machine learning model based on the second plurality of data associated with the second one or more images corresponding to the first one or more products, comprises: (a) receiving, by the one or more hardware processors, the second plurality of data associated with the second one or more images corresponding to the first one or more products, (b) providing, by the one or more hardware processors, a first plurality of labels related to the second one or more images corresponding to the first one or more products, to the machine learning model, and (c) training, by the one or more hardware processors, the machine learning model by correlating the second one or more images corresponding to the first one or more products, with the first plurality of labels related to the second one or more images.

The first plurality of labels comprises at least one of: object comprised in the second one or more images, coordinates, color information, and metadata, of the second one or more images. The machine learning model is a supervised machine learning model.

In another embodiment, analyzing, using the transfer learning method, the third one or more images corresponding to the second one or more products, comprises: (a) obtaining, by the one or more hardware processors, the third one or more images corresponding to the second one or more products from the database, and (b) providing, by the one or more hardware processors, a second plurality of labels related to the third one or more images corresponding to the second one or more products. The second plurality of labels comprises of names of the second one or more products to fine-tune the machine learning model.

In one embodiment, the fine-tuning is a transfer learning technique in which the machine learning model trained to recognize the first one or more images, is retrained to recognize the second one or more images corresponding to the first one or more products. The machine learning model is retrained on the second one or more images corresponding to the first one or more products. The fine-tuning subsystem is configured to fine-tune the machine learning model trained on the first one or more images infrequently.

In yet another embodiment, fine-tuning the at least one subset of the trained machine learning model, comprises training, by the one or more hardware processors, weights of the at least one subset of the machine learning model already fine-tuned on the second one or more images corresponding to the first one or more products. The at least one subset of the machine learning model is retrained on the third one or more images corresponding to the second one or more products.

In yet another embodiment, analyzing, using the transfer learning method, the fourth one or more images corresponding to the second one or more products, comprises: (a) obtaining, by the one or more hardware processors, the fourth one or more images corresponding to the second one or more products, (b) providing, by the one or more hardware processors, the fourth one or more images corresponding to the second one or more products, to the fine-tuned at least one subset of the trained machine learning model, (c) applying, by the one or more hardware processors, the trained weights of the fine-tuned at least one subset of the trained machine learning model, on the fourth one or more images corresponding to the second one or more products, and (d) analyzing, by the one or more hardware processors, the fourth one or more images corresponding to the second one or more products, based on the trained weights of the fine-tuned at least one subset of the trained machine learning model applied on the fourth one or more images corresponding to the second one or more products. The fourth one or more images corresponding to the second one or more products comprises the one or more real world test images for analysis.

In yet another embodiment, the fourth one or more images corresponding to the second one or more products is analyzed by providing probabilistic values to the fourth one or more analyzed images corresponding to the second one or more products, between 0 and 1.

In yet another embodiment, the trained machine learning model is a convolutional neural network (CNN) model.

In yet another embodiment, the first one or more products and the second one or more products are different products.

In another aspect, a non-transitory computer-readable storage medium having instructions stored therein that when executed by one or more hardware processors, cause the one or more hardware processors to execute operations of: (a) obtaining a plurality of data associated with first one or more images, (b) training the machine learning model on a second plurality of data associated with second one or more images corresponding to first one or more products, (c) extracting a third plurality of data associated with third one or more images corresponding to second one or more products from a database, (d) analyzing the third one or more images corresponding to the second one or more products using the machine learning model trained on the second one or more images corresponding to the first one or more products, using a transfer learning method, (e) fine-tuning at least one subset of the machine learning model to recognize the third one or more analyzed images corresponding to the second one or more products, and (f) analyzing fourth one or more images corresponding to the second one or more products using the fine-tuned at least one subset of the trained machine learning model trained on the third one or more recognized images corresponding to the second one or more products, using the transfer learning method.

The first one or more images is obtained from an imagenet database. The second one or more images in the database comprises one or more images corresponding to the first one or more products, irrespective of whether the second one or more images comprises of one or more products on which the trained machine learning model is to be performed.

A number of the first one or more products is higher than a number of the second one or more products. The fine-tuned at least one subset of the trained machine learning model trained on the third one or more images, is required during learning to analyze the second one or more products. The fourth one or more images comprises one or more real world test images corresponding to the second one or more products. The fine-tuned at least one subset of the trained machine learning model is performed for analyzing the one or more real world test images corresponding to the second one or more products.

In an embodiment, training the machine learning model based on the second plurality of data associated with the second one or more images corresponding to the first one or more products, comprises: (a) receiving the second plurality of data associated with the second one or more images corresponding to the first one or more products, (b) providing a first plurality of labels related to the second one or more images corresponding to the first one or more products, to the machine learning model, and (c) training the machine learning model by correlating the second one or more images corresponding to the first one or more products, with the first plurality of labels related to the second one or more images.

The first plurality of labels comprises at least one of: object comprised in the second one or more images, coordinates, color information, and metadata, of the second one or more images. The machine learning model is a supervised machine learning model.

In another embodiment, analyzing, using the transfer learning method, the third one or more images corresponding to the second one or more products, comprises: (a) obtaining the third one or more images corresponding to the second one or more products from the database, and (b) providing a second plurality of labels related to the third one or more images corresponding to the second one or more products. The second plurality of labels comprises of names of the second one or more products to fine-tune the machine learning model.

In one embodiment, the fine-tuning is a transfer learning technique in which the machine learning model trained to recognize the first one or more images, is retrained to recognize the second one or more images corresponding to the first one or more products. The machine learning model is retrained on the second one or more images corresponding to the first one or more products. The fine-tuning subsystem is configured to fine-tune the machine learning model trained on the first one or more images infrequently.

In yet another embodiment, fine-tuning the at least one subset of the trained machine learning model, comprises training weights of the at least one subset of the machine learning model already fine-tuned on the second one or more images corresponding to the first one or more products. The at least one subset of the machine learning model is retrained on the third one or more images corresponding to the second one or more products.

In yet another embodiment, analyzing, using the transfer learning method, the fourth one or more images corresponding to the second one or more products, comprises: (a) obtaining the fourth one or more images corresponding to the second one or more products, (b) providing the fourth one or more images corresponding to the second one or more products, to the fine-tuned at least one subset of the trained machine learning model, (c) applying the trained weights of the fine-tuned at least one subset of the trained machine learning model, on the fourth one or more images corresponding to the second one or more products, and (d) analyzing the fourth one or more images corresponding to the second one or more products, based on the trained weights of the fine-tuned at least one subset of the trained machine learning model applied on the fourth one or more images corresponding to the second one or more products. The fourth one or more images corresponding to the second one or more products comprises the one or more real world test images for analysis.

In yet another embodiment, the fourth one or more images corresponding to the second one or more products is analyzed by providing probabilistic values to the fourth one or more analyzed images corresponding to the second one or more products, between 0 and 1.

In yet another embodiment, the trained machine learning model is a convolutional neural network (CNN) model.

In yet another embodiment, the first one or more products and the second one or more products are different products.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based system for optimizing training time of a machine learning model, in accordance with an embodiment of the present disclosure;

FIG. 2 is a detailed view of the machine learning based system, in accordance with another embodiment of the present disclosure;

FIG. 3 is a schematic representation depicting that third one or more analyzed images corresponding to second one or more products is recognized by fine-tuning at least one subset of the machine learning model, in accordance with an embodiment of the present disclosure; and

FIG. 4 is a flow chart illustrating a machine learning based method for optimizing training time of the machine learning model, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”. “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

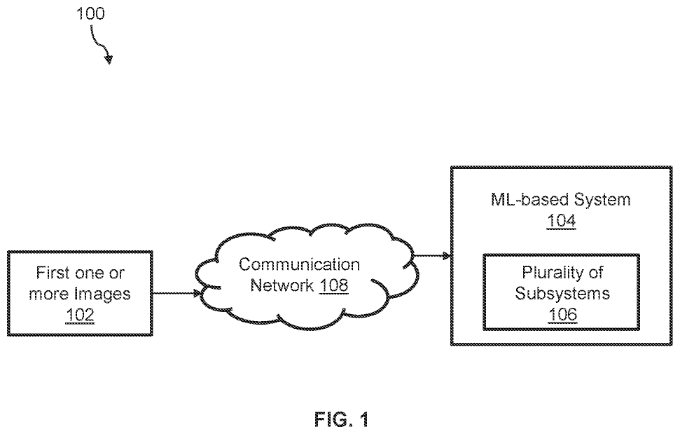

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

According to an embodiment, the terms ‘-storage unit’ and “database” are used interchangeably throughout the below description.

FIG. 1 is a block diagram 100 illustrating a computing environment with a machine learning based system 104 for optimizing training time of a machine learning model, in accordance with an embodiment of the present disclosure. The machine learning based system 104 is configured to obtain a plurality of data associated with first one or more images 102. In an embodiment, the first one or more images 102 is stored in an imagenet database from which the machine learning based system 104 is configured to obtain the first one or more images 102 through a communication network 108. In an embodiment, the communication network 108 may be at least one of: a wireless communication network, and a wired communication network.

The machine learning based system 104 is further configured to train the machine learning model (e.g., a machine learning retail image recognition model) based on a second plurality of data associated with second one or more images corresponding to first one or more products. In an embodiment, the second one or more images belonging to a database including one or more images corresponding to the first one or more products, is not necessarily including the one or more images corresponding to the first one or more products on which the trained machine learning model aims to work.

The machine learning based system 104 is further configured to extract a third plurality of data associated with third one or more images corresponding to second one or more products from the database. In an embodiment, the third one or more images corresponding to the second one or more products, are pre-stored in the database. The machine learning based system 104 is further configured to learn to recognize the third one or more images corresponding to the second one or more products by fine-tuning the machine learning model trained on the second one or more images corresponding to the first one or more products, using a transfer learning method. In an embodiment, a number of the first one or more products is higher than a number of the second one or more products.

The machine learning based system 104 is further configured to fine-tune at least one subset of the trained machine learning model to recognize the third one or more analyzed images corresponding to the second one or more products. The machine learning based system 104 is further configured to analyze fourth one or more images corresponding to the second one or more products using the fine-tuned at least one subset of the trained machine learning model trained on the third one or more recognized images corresponding to the second one or more products, using the transfer learning method.

In an embodiment, the fine-tuned at least one subset of the trained machine learning model trained on the third one or more images, is required during learning to recognize the second one or more products. In an embodiment, the fourth one or more images includes one or more real world test images corresponding to the second one or more products. The fine-tuned at least one subset of the trained machine learning model is performed for analyzing the one or more real world test images corresponding to the second one or more products.

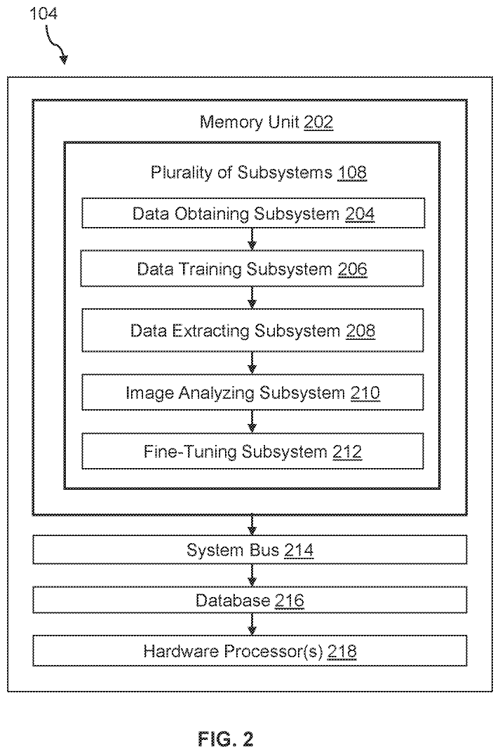

In an embodiment of the present disclosure, the machine learning based system 104 includes a plurality of subsystems 106. Details on the plurality of subsystems 106 have been elaborated in subsequent paragraphs of the present description with reference to FIG. 2.

FIG. 2 is a detailed view of the machine learning based system 104 for optimizing the training time of the machine learning model, in accordance with an embodiment of the present disclosure. The machine learning based system 104 includes a memory unit 202, one or more hardware processors 218, and a storage unit (i.e., database) 216. The one or more hardware processors 218, the memory unit 202 and the storage unit 216 are communicatively coupled through a system bus 214 or any similar mechanism. The memory unit 202 includes the plurality of subsystems 106 in the form of programmable instructions executable by the one or more hardware processors 218.

The plurality of subsystems 106 includes a data obtaining subsystem 204, a data training subsystem 206, a data extracting subsystem 208, an image analyzing subsystem 210, and a fine tuning subsystem 212.

The one or more hardware processors 218, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 218 may also include embedded controllers, such as generic or programmable logic devices or arrays, application specific integrated circuits, single-chip computers, and the like.

The memory unit 202 may be non-transitory volatile memory and non-volatile memory. The memory unit 202 may be coupled for communication with the one or more hardware processors 218, such as being a computer-readable storage medium. The one or more hardware processors 218 may execute machine-readable instructions and/or source code stored in the memory unit 202. A variety of machine-readable instructions may be stored in and accessed from the memory unit 202.

The memory unit 202 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory unit 202 includes the plurality of subsystems 106 stored in the form of machine-readable instructions on any of the above-mentioned storage media and may be in communication with and executed by the one or more hardware processors 218.

The storage unit 216 may be a cloud storage, a Structured Query Language (SQL) data store or a location on a file system directly accessible by the plurality of subsystems 106.

The plurality of subsystems 106 includes the data obtaining subsystem 204 that is communicatively connected to the one or more hardware processors 218. The data obtaining subsystem 204 is configured to obtain the plurality of data associated with the first one or more images 102. In an embodiment, the first one or more images 102 is obtained from the imagenet database.

The plurality of subsystems 106 further includes the data training subsystem 206 that is communicatively connected to the one or more hardware processors 218. The data training subsystem 206 is configured to train the machine learning model based on the second plurality of data associated with the second one or more images corresponding to the first one or more products. In an embodiment, the second one or more images belonging to the database 216 including the one or more images corresponding to the first one or more products, is not necessarily including the one or more images corresponding to the second one or more products on which the trained machine learning model aims to work.

For training the machine learning model based on the second plurality of data associated with the second one or more images corresponding to the first one or more products, the data training subsystem 206 is configured to receive the second plurality of data associated with the second one or more images corresponding to the first one or more products.

The data training subsystem 206 is further configured to provide a first plurality of labels related to the second one or more images corresponding to the first one or more products, to the machine learning model. In an embodiment, the plurality of labels includes at least one of: objects comprised in the second one or more images, and coordinates, color information, and metadata, of the second one or more images. The data training subsystem 206 is further configured to train the machine learning model by correlating the second one or more images corresponding to the first one or more products, with the plurality of labels related to the second one or more images. In an embodiment, the machine learning model is a supervised machine learning model. In another embodiment, the machine learning model may be at least one of: a convolutional neural network model (CNN), a linear regression model, a logistic regression model, a decision tree, a random forest model, and the like.

The plurality of subsystems 106 further includes the data extracting subsystem 208 that is communicatively connected to the one or more hardware processors 218. The data extracting subsystem 208 is configured to extract the third plurality of data associated with the third one or more images corresponding to the second one or more products from the database 216. In an embodiment, the third one or more images corresponding to the second one or more products, are pre-stored in the database 216. In an embodiment, the first one or more products and the second one or more products are different products.

The plurality of subsystems 106 includes the image analyzing subsystem 210 that is communicatively connected to the one or more hardware processors 218. The image analyzing subsystem 210 is configured to learn to recognize the third one or more images corresponding to the second one or more products by fine-tuning the machine learning model trained on the second one or more images corresponding to the first one or more products, using a transfer learning method. For analyzing the third one or more images corresponding to the second one or more products, the image analyzing subsystem 210 is configured to obtain the third one or more images corresponding to the second one or more products from the database 216.

The image analyzing subsystem 210 is further configured to provide a second plurality of labels related to the third one or more images corresponding to the second one or more products. In an embodiment, the second plurality of labels includes names of the second one or more products to fine-tune the machine learning model.

In an embodiment, the fine-tuning is a transfer learning technique in which the machine learning model trained to recognize the first one or more images 102. Further, the machine learning model trained to recognize the first one or more images 102, is retrained to recognize the second one or more images corresponding to the first one or more products. The machine learning model is retrained on the second one or more recognized images corresponding to the first one or more products. In an embodiment, the fine-tuning subsystem 212 is configured to fine-tune the machine learning model trained on the first one or more images infrequently.

The plurality of subsystems 106 includes the fine-tuning subsystem 212 that is communicatively connected to the one or more hardware processors 218. The fine-tuning subsystem 212 is configured to fine-tune the at least one subset of the trained machine learning model to recognize the third one or more analyzed images corresponding to the second one or more products. For fine-tuning the at least one subset of the trained machine learning model, the fine-tuning subsystem 212 is configured to train weights of at least one subset of the machine learning model already fine-tuned on the second one or more images corresponding to the first one or more products. The at least one subset of the machine learning model is retrained on the third one or more images corresponding to the second one or more products. In an embodiment, the first one or more products is deliberately higher than the second one or more products.

The image analyzing subsystem 210 is further configured to analyze the fourth one or more images corresponding to the second one or more products using the fine-tuned at least one subset of the trained machine learning model trained on the third one or more recognized images corresponding to the second one or more products, using the transfer learning method. For analyzing the fourth one or more images corresponding to the second one or more products, the image analyzing subsystem 210 is configured to obtain the fourth one or more images corresponding to the second one or more products. In an embodiment, the fourth one or more images corresponding to the second one or more products includes the one or more real world test images for analysis. The image analyzing subsystem 210 is further configured to provide the fourth one or more images corresponding to the second one or more products, to the fine-tuned at least one subset of the trained machine learning model.

The image analyzing subsystem 210 is further configured to apply the trained weights of the fine-tuned at least one subset of the trained machine learning model, on the fourth one or more images corresponding to the second one or more products. The image analyzing subsystem 210 is further configured to analyze the fourth one or more images corresponding to the second one or more products, based on the trained weights of the fine-tuned at least one subset of the machine learning model applied on the fourth one or more images corresponding to the second one or more products.

In an embodiment, the fine-tuned at least one subset of the machine learning model trained on the third one or more images, is required during learning to recognize the second one or more products. The fine-tuned at least one subset of the trained machine learning model is performed for analyzing the one or more real world test images corresponding to the second one or more products.

In an embodiment, the image analyzing subsystem 210 is configured to analyze the fourth one or more images corresponding to the second one or more products, by providing probabilistic values to the fourth one or more analyzed images corresponding to the second one or more products, between 0 and 1.

In an embodiment, the fourth one or more images is provided from the one or more real world test images corresponding to the second one or more products. The fine-tuning of at least one subset of the trained machine learning model is frequently performed to analyze the one or more real world test images (i.e., the fourth one or more images), which leads to minimize at least one of: the training time of the machine learning model and resources when compared to fine-tuning of the whole machine learning model trained on the first one or more images 102, and the third one or more images corresponding to the second one or more products frequently.

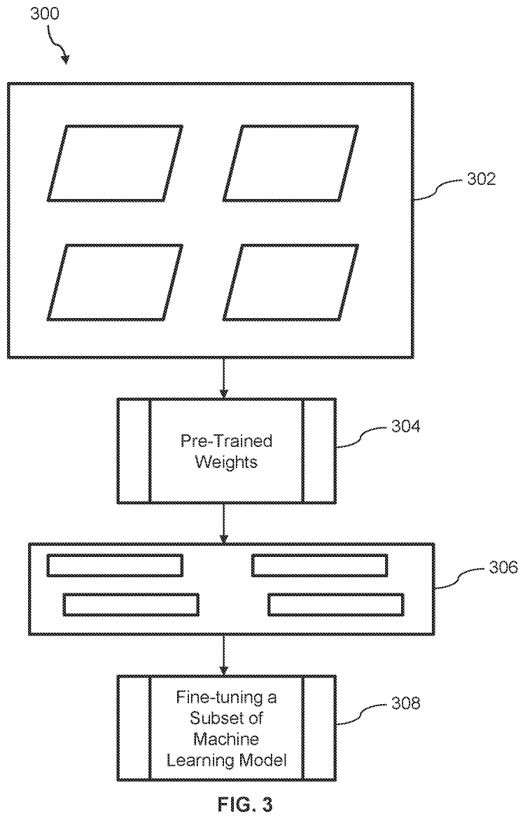

FIG. 3 is a schematic representation 300 depicting that the third one or more analyzed images corresponding to second one or more products is recognized by fine-tuning the at least one subset of the machine learning model, in accordance with an embodiment of the present disclosure. FIG. 3 depicts that the fine-tuning subsystem 212 is configured to fine-tune 308 the at least one subset of the trained machine learning model 306, from a frozen part 302 of the trained machine learning model, by training 304 the weights of the at least one subset of the machine learning model fine-tuned on the second one or more images corresponding to the first one or more products. The at least one subset of the machine learning model 306 is retrained on the second one or more images corresponding to the first one or more products to recognize the third one or more images corresponding to the second one or more products.

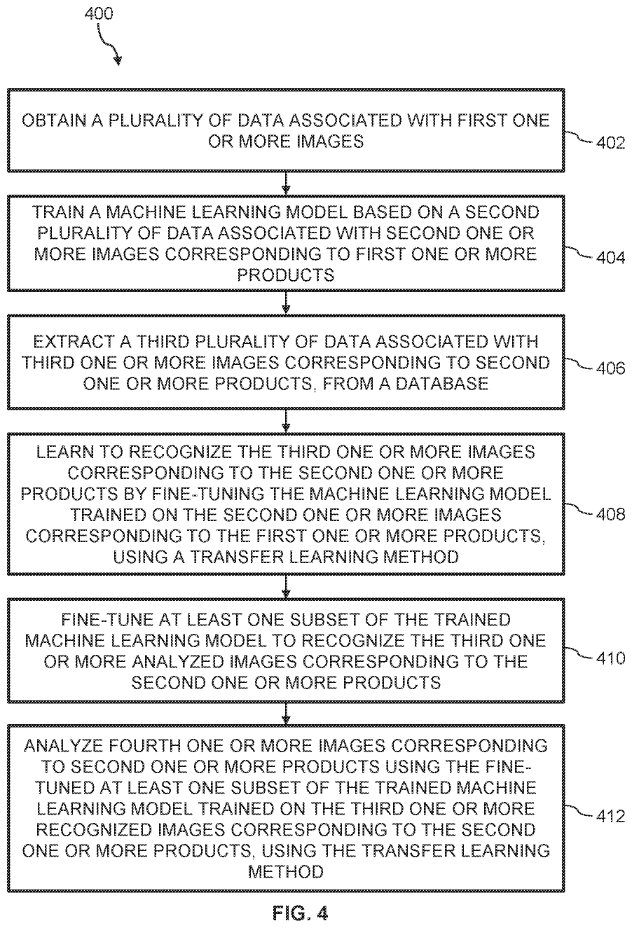

FIG. 4 is a flow chart illustrating a machine learning based method 400 for optimizing the training time of the machine learning model, in accordance with an embodiment of the present disclosure.

At step 402, the plurality of data associated with the first one or more images 102 is obtained. In an embodiment, the plurality of data associated with the first one or more images 102 is obtained from the imagenet database.

At step 404, the machine learning model is trained based on the second plurality of data associated with the second one or more images corresponding to the first one or more products. In an embodiment, the second one or more images in the database 216 including the one or more images corresponding to the first one or more products, is not necessarily including the one or more images on which the trained machine learning model aims to work.

At step 406, the third plurality of data associated with the third one or more images corresponding to the second one or more products, is extracted from the database 216. In an embodiment, the second one or more images corresponding to the second one or more products, are pre-stored in the database 216.

At step 408, the third one or more images corresponding to the second one or more products is learned to recognize by fine-tuning the machine learning model trained on the second one or more images corresponding to the first one or more products, using a transfer learning method. In an embodiment, the number of the first one or more products is higher than the number of the second one or more products.

At step 410, the at least one subset of the trained machine learning model is fine-tuned to recognize the third one or more analyzed images corresponding to the second one or more products.

At step 412, the fourth one or more images corresponding to the second one or more products, is analyzed using the fine-tuned at least one subset of the trained machine learning model trained on the third one or more recognized images corresponding to the second one or more products, using the transfer learning method.

In an embodiment, the fine-tuned at least one subset of the trained machine learning model trained on the third one or more images, is required during learning to recognize the second one or more products. In an embodiment, the fourth one or more images comprises the one or more real world test images corresponding to the second one or more products. The fine-tuned at least one subset of the trained machine learning model is performed for analyzing the one or more real world test images corresponding to the second one or more products.

The present invention has following advantages. The machine learning based system 104 of the present invention is configured with the machine learning model that is trained on a large number of unrelated one or more products (i.e., the first one or more products), to extract features for new one or more products (i.e., the second one or more products). Further, the machine learning based system 104 of the present invention is further configured with the fine-tuned at least one subset of the trained machine learning model trained on the features with similar levels of accuracy as training an entire machine learning model for each dataset individually.

The training time of the machine learning model is very fast, and the machine learning model has accuracy similar to the full fine-tuning method, when the machine learning model is trained on the large number of unrelated one or more products and is used to extract the features and then trained on the extracted features.

The machine learning based system 104 of the present invention is configured to check the machine learning model quickly and retrain the machine learning model due to fast turn-around time when the machine learning model is not trained well. The machine learning based system 104 of the present invention is further configured to train the machine learning model on thousands of unique products based on efficient training time of the machine learning model.

Traditional methods involve fine-tuning an entire machine learning model trained on the first one or more images 102 and the third one or more images corresponding to the second one or more products, to be able to recognize the fourth one or more images corresponding to the second one or more products. This fine-tuning of the entire machine learning model is costlier in time and resource wise. Hence, the machine learning based system 104 of the present invention is configured to fine-tune the machine learning model trained on the first one or more products that is stored in the database 216, occasionally, where the first one or more products is higher than the second one or more products.

The fine-tuning of at least one subset of the trained machine learning model is frequently performed to analyze the one or more real world test images (i.e., the fourth one or more images), which leads to minimize at least one of: the training time of the machine learning model and resources w % ben compared to the fine-tuning of the entire machine learning model trained on the first one or more images 102, and the third one or more images corresponding to the second one or more products frequently.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the machine learning based system 104 either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer system in accordance with the embodiments herein. The machine learning based system 104 herein comprises at least one processor or central processing unit (CPU). The CPUs are interconnected via the system bus 214 to various devices such as a random-access memory (RAM), read-only memory (ROM), and an input/output (I/O) adapter. The I/O adapter can connect to peripheral devices, such as disk units and tape drives, or other program storage devices that are readable by the machine learning based system 104. The machine learning based system 104 can read the inventive instructions on the program storage devices and follow these instructions to execute the methodology of the embodiments herein.

The machine learning based system 104 further includes a user interface adapter that connects a keyboard, mouse, speaker, microphone, and/or other user interface devices such as a touch screen device (not shown) to the bus to gather user input. Additionally, a communication adapter connects the bus to a data processing network, and a display adapter connects the bus to a display device which may be embodied as an output device such as a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A machine learning based system for optimizing learning time of a machine learning model, wherein the machine learning based system comprising:
one or more hardware processors; and
a memory unit coupled to the one or more hardware processors, wherein the memory unit comprises a set of program instructions in form of a plurality of subsystems, configured to be executed by the one or more hardware processors, wherein the plurality of subsystems comprises:
a data obtaining subsystem configured to obtain a plurality of data associated with first one or more images, wherein the first one or more images is obtained from an imagenet database;
a data training subsystem configured to train the machine learning model on a second plurality of data associated with second one or more images corresponding to first one or more products,
wherein the second one or more images in a database comprises one or more images corresponding to the first one or more products, irrespective of whether the second one or more images comprises of one or more products on which the trained machine learning model is to be performed;
a data extracting subsystem configured to extract a third plurality of data associated with third one or more images corresponding to second one or more products from the database, wherein the third one or more images corresponding to the second one or more products, are pre-stored in the database;
an image analyzing subsystem configured to learn to recognize the third one or more images corresponding to the second one or more products by fine-tuning the machine learning model trained on the second one or more images corresponding to the first one or more products, using a transfer learning method,
wherein a number of the first one or more products is higher than a number of the second one or more products;
a fine-tuning subsystem configured to fine-tune at least one subset of the trained machine learning model to recognize the third one or more analyzed images corresponding to the second one or more products; and
the image analyzing subsystem configured to analyze fourth one or more images corresponding to the second one or more products using the fine-tuned at least one subset of the trained machine learning model trained on the third one or more recognized images corresponding to the second one or more products, using the transfer learning method,
wherein the fine-tuned at least one subset of the trained machine learning model trained on the third one or more images, is required during learning to recognize the second one or more products,
wherein the fourth one or more images comprises one or more real world test images corresponding to the second one or more products, and
wherein the fine-tuned at least one subset of the trained machine learning model is performed for analyzing the one or more real world test images corresponding to the second one or more products.

2. The machine learning based system of claim 1, wherein in training the machine learning model based on the second plurality of data associated with the second one or more images corresponding to the first one or more products, the data training subsystem is configured to:
receive the second plurality of data associated with the second one or more images corresponding to the first one or more products;
provide a first plurality of labels related to the second one or more images corresponding to the first one or more products, to the machine learning model, wherein the first plurality of labels comprises at least one of: object comprised in the second one or images, coordinates, color information, and metadata, of the second one or more images; and
train the machine learning model by correlating the second one or more images corresponding to the first one or more products, with the first plurality of labels related to the second one or more images, wherein the machine learning model is a supervised machine learning model.

3. The machine learning based system of claim 1, wherein in analyzing, using the transfer learning method, the third one or more images corresponding to the second one or more products, the image analyzing subsystem is configured to:
obtain the third one or more images corresponding to the second one or more products from the database; and
provide a second plurality of labels related to the third one or more images corresponding to the second one or more products, wherein the second plurality of labels comprises of names of the second one or more products to fine-tune the machine learning model,
wherein the fine-tuning is a transfer learning technique in which the machine learning model trained to recognize the first one or more images,
wherein the machine learning model trained to recognize the first one or more images, is retrained to recognize the second one or more images corresponding to the first one or more products,
wherein the machine learning model is retrained on the second one or more recognized images corresponding to the first one or more products, and
wherein the fine-tuning subsystem is configured to fine-tune the machine learning model trained on the first one or more images infrequently.

4. The machine learning based system of claim 1, wherein in fine-tuning the at least one subset of the trained machine learning model, the fine-tuning subsystem is configured to:
train weights of the at least one subset of the machine learning model, which is fine-tuned on at least one of: the second one or more images, the third one or more images corresponding to the second one or more products,
wherein the at least one subset of the machine learning model is retrained on the second one or more images.

5. The machine learning based system of claim 1, wherein in analyzing, using the transfer learning method, the fourth one or more images corresponding to the second one or more products, the image analyzing subsystem is configured to:
obtain the fourth one or more images corresponding to the second one or more products, wherein the fourth one or more images corresponding to the second one or more products comprises the one or more real world test images for analysis;
provide the fourth one or more images corresponding to the second one or more products, to the fine-tuned at least one subset of the trained machine learning model;
apply the trained weights of the fine-tuned at least one subset of the trained machine learning model, on the fourth one or more images corresponding to the second one or more products; and
analyze the fourth one or more images corresponding to the second one or more products, based on the trained weights of the fine-tuned at least one subset of the trained machine learning model applied on the fourth one or more images corresponding to the second one or more products.

6. The Machine Learning based system of claim 5, wherein the image analyzing subsystem is configured to analyze the fourth one or more images corresponding to the second one or more products, by providing probabilistic values to the fourth one or more analyzed images corresponding to the second one or more products, between 0 and 1.

7. The Machine Learning based system of claim 1, wherein the trained machine learning model is a convolutional neural network (CNN) model.

8. The Machine Learning based system of claim 1, wherein the first one or more products and the second one or more products are different products.

9. A machine learning based method for optimizing training time of a machine learning model, the machine learning based method comprising:
obtaining, by one or more hardware processors, a plurality of data associated with first one or more images, wherein the first one or more images is obtained from an imagenet database;
training, by the one or more hardware processors, the machine learning model based on a second plurality of data associated with second one or more images corresponding to first one or more products,
wherein the second one or more images in a database comprises one or more images corresponding to the first one or more products, irrespective of whether the second one or more images comprises of one or more products on which the trained machine learning model is to be performed;
extracting, by the one or more hardware processors, a third plurality of data associated with third one or more images corresponding to second one or more products from the database, wherein the third one or more images corresponding to the second one or more products, are pre-stored in the database;
analyzing, by the one or more hardware processors, the third one or more images corresponding to the second one or more products using the machine learning model trained on the second one or more images corresponding to the first one or more products, using a transfer learning method,
wherein a number of the first one or more products is higher than a number of the second one or more products;
fine-tuning, by the one or more hardware processors, at least one subset of the trained machine learning model to recognize the third one or more analyzed images corresponding to the second one or more products; and
analyzing, by the one or more hardware processors, fourth one or more images corresponding to the second one or more products using the fine-tuned at least one subset of the trained machine learning model trained on the third one or more recognized images corresponding to the second one or more products, using the transfer learning method,
wherein the fine-tuned at least one subset of the trained machine learning model trained on the third one or more images, is required during learning to recognize the second one or more products,
wherein the fourth one or more images comprises one or more real world test images corresponding to the second one or more products, and
wherein the fine-tuned at least one subset of the trained machine learning model is performed for analyzing the one or more real world test images corresponding to the second one or more products.

10. The machine learning based method of claim 9, wherein training the machine learning model based on the second plurality of data associated with the second one or more images corresponding to the first one or more products, comprises:
receiving, by the one or more hardware processors, the second plurality of data associated with the second one or more images corresponding to the first one or more products;
providing, by the one or more hardware processors, a first plurality of labels related to the second one or more images corresponding to the first one or more products, to the machine learning model, wherein the first plurality of labels comprises at least one of: object comprised in the second one or more images, coordinates, color information, and metadata, of the second one or more images; and
training, by the one or more hardware processors, the machine learning model by correlating the second one or more images corresponding to the first one or more products, with the first plurality of labels related to the second one or more images, wherein the machine learning model is a supervised machine learning model.

11. The machine learning based method of claim 9, wherein analyzing, using the transfer learning method, the third one or more images corresponding to the second one or more products, comprises:
obtaining, by the one or more hardware processors, the third one or more images corresponding to the second one or more products from the database; and
providing, by the one or more hardware processors, a second plurality of labels related to the third one or more images corresponding to the second one or more products, wherein the second plurality of labels comprises of names of the second one or more products to fine-tune the machine learning model,
wherein the fine-tuning is a transfer learning technique in which the machine learning model trained to recognize the first one or more images,
wherein the machine learning model trained to recognize the first one or more images, is retrained to recognize the second one or more images corresponding to the first one or more products,
wherein the machine learning model is retrained on the second one or more images corresponding to the first one or more products, and
wherein the fine-tuning subsystem is configured to fine-tune the machine learning model trained on the first one or more images infrequently.

12. The machine learning based method of claim 9, wherein fine-tuning the at least one subset of the trained machine learning model, comprises:
training, by the one or more hardware processors, weights of the at least one subset of the machine learning model fine-tuned on the second one or more images corresponding to the first one or more products,
wherein the at least one subset of the machine learning model is retrained on the second one or more recognized images to recognize the third one or more images corresponding to the second one or more products.

13. The machine learning based method of claim 9, wherein analyzing, using the transfer learning method, the fourth one or more images corresponding to the second one or more products, comprises:
obtaining, by the one or more hardware processors, the fourth one or more images corresponding to the second one or more products, wherein the fourth one or more images corresponding to the second one or more products comprises the one or more real world test images for analysis;
providing, by the one or more hardware processors, the fourth one or more images corresponding to the second one or more products, to the fine-tuned at least one subset of the trained machine learning model;
applying, by the one or more hardware processors, the trained weights of the fine-tuned at least one subset of the trained machine learning model, on the fourth one or more images corresponding to the second one or more products, and
analyzing, by the one or more hardware processors, the fourth one or more images corresponding to the second one or more products, based on the trained weights of the fine-tuned at least one subset of the trained machine learning model applied on the fourth one or more images corresponding to the second one or more products.

14. The machine learning based method of claim 13, wherein the fourth one or more images corresponding to the second one or more products is analyzed by providing probabilistic values to the fourth one or more analyzed images corresponding to the second one or more products, between 0 and 1.

15. The machine learning based method of claim 9, wherein the trained machine learning model is a convolutional neural network (CNN) model.

16. The machine learning based method of claim 9, wherein the first one or more products and the second one or more products are different products.

17. A non-transitory computer-readable storage medium having instructions stored therein that when executed by one or more hardware processors, cause the one or more hardware processors to execute operations of:
obtaining a plurality of data associated with first one or more images, wherein the first one or more images is obtained from an imagenet database;
training the machine learning model based on a second plurality of data associated with the second one or more images corresponding to first one or more products,
wherein the second one or more images in a database comprises one or more images corresponding to the first one or more products, irrespective of whether the second one or more images comprises of one or more products on which the trained machine learning model is to be performed;
extracting a third plurality of data associated with third one or more images corresponding to the second one or more products from the database, wherein the third one or more images corresponding to the second one or more products, are pre-stored in the database;
analyzing the third one or more images corresponding to the second one or more products using the machine learning model trained on the second one or more images corresponding to the first one or more products, using a transfer learning method,
wherein a number of the first one or more products is higher than a number of the second one or more products;
fine-tuning at least one subset of the trained machine learning model to recognize the third one or more analyzed images corresponding to the second one or more products; and
analyzing fourth one or more images corresponding to the second one or more products using the fine-tuned at least one subset of the trained machine learning model trained on the third one or more recognized images corresponding to the second one or more products, using the transfer learning method,
wherein the fine-tuned at least one subset of the trained machine learning model trained on the third one or more images, is required during learning to recognize the second one or more products,
wherein the fourth one or more images comprises one or more real world test images corresponding to the second one or more products, and
wherein the fine-tuned at least one subset of the trained machine learning model is performed for analyzing the one or more real world test images corresponding to the second one or more products.

18. The non-transitory computer-readable storage medium of claim 17, wherein training the machine learning model based on the second plurality of data associated with the second one or more images corresponding to the first one or more products, comprises:
receiving the second plurality of data associated with the second one or more images corresponding to the first one or more products,
providing a first plurality of labels related to the second one or more images corresponding to the first one or more products, to the machine learning model, wherein the first plurality of labels comprises at least one of; object comprised in the second one or more images, coordinates, color information, and metadata, of the one or more images; and
training the machine learning model by correlating the second one or more images corresponding to the first one or more products, with the first plurality of labels related to the second one or more images, wherein the machine learning model is a supervised machine learning model.

19. The non-transitory computer-readable storage medium of claim 17, wherein analyzing, using the transfer learning method, the third one or more images corresponding to the second one or more products, comprises:
obtaining the third one or more images corresponding to the second one or more products from the database;
providing a second plurality of labels related to the third one or more images corresponding to the second one or more products, wherein the second plurality of labels comprises of names of the second one or more products to fine-tune the machine learning model,
wherein the fine-tuning is a transfer learning technique in which the machine learning model trained to recognize the first one or more images,
wherein the machine learning model trained to recognize the first one or more images, is retrained to recognize the second one or more images corresponding to the first one or more products,
wherein the machine learning model is retrained on the second one or more images corresponding to the first one or more products, and
wherein the fine-tuning subsystem is configured to fine-tune the machine learning model trained on the first one or more images infrequently.

20. The non-transitory computer-readable storage medium of claim 17, wherein fine-tuning the at least one subset of the trained machine learning model, comprises:
training weights of the at least one subset of the machine learning model fine-tuned on the third one or more images corresponding to the second one or more products,
wherein the at least one subset of the machine learning model is retrained on the second one or more recognized images to recognize the third one or more images corresponding to the second one or more products.

21. The non-transitory computer-readable storage medium of claim 17, wherein analyzing, using the transfer learning method, the fourth one or more images corresponding to the second one or more products, comprises:
obtaining the fourth one or more images corresponding to the second one or more products, wherein the fourth one or more images corresponding to the second one or more products comprises the one or more real world test images for analysis;
providing the fourth one or more images corresponding to the second one or more products, to the fine-tuned at least one subset of the trained machine learning model;
applying the trained weights of the fine-tuned at least one subset of the trained machine learning model, on the fourth one or more images corresponding to the second one or more products; and
analyzing the fourth one or more images corresponding to the second one or more products, based on the trained weights of the fine-tuned at least one subset of the trained machine learning model applied on the fourth one or more images corresponding to the second one or more products.

22. The non-transitory computer-readable storage medium of claim 21, wherein the fourth one or more images corresponding to the second one or more products is analyzed by providing probabilistic values to the fourth one or more analyzed images corresponding to the second one or more products, between 0 and 1.

23. The non-transitory computer-readable storage medium of claim 17, wherein the trained machine learning model is a convolutional neural network (CNN) model.

24. The non-transitory computer-readable storage medium of claim 17, wherein the first one or more products and the second one or more products are different products.
